(19) United States
(12) Patent Application Publication
(10) Pub. No.: US 2002/0198884 A1
(43) Pub. Date: Dec. 26, 2002

(54) Method for providing a service for organizing meetings for users of a communication network, and communication network, service computer and program madule therefore

(75) Inventor: Bernd Eisinger, Stockern (AT)

Correspondence Address: SUGHRUE, MION, ZINN,, MACPEAK & SEAS, PLLC, 2100 Pennsylvania Avenue, N.W., Washington, DC, 20037-3213, US

(73) Assignee: ALCATEL

(21) Appl. No.: 10/167,658

(22) Filed: Jun. 13, 2002

(30) Foreign Application Priority Data
Jun. 26, 2001 (EP) 01 440 239.0

(51) Int. Cl. G06F 17/30

(52) U.S. Cl. 707/10

(57) ABSTRACT

Method for providing a service for organizing meetings for users of a communication network, the service computer receiving and storing a meeting proposal with at least one meeting criterion of a proposing user, the service computer receiving a meeting request with at least one search criterion of a searching user, the service computer ascertaining meeting proposals of which meeting criteria correspond to the transmitted search criteria and, if one or more meeting proposals are ascertained, transmitting to the searching user at least one of these meeting proposals together with, respectively, current information on participants for whom messages are stored, the service computer receiving an attendance confirmation of the searching user in respect of a selected meeting proposal and storing the attendance confirmation of this user in the service computer as a message, and a communication network, service computer and program module for the same.

### BACKGROUND OF THE INVENTION

The invention is based on a priority application EP 01 440 239.0 which is hereby incorporated by reference. The invention concerns a method for providing a service for organizing meetings for users of a communication network, and a communication network, a service computer and a program module, to be executed in a service computer therefore.

Frequently, meetings or events are planned with a sufficient lead time and for a defined group of participants. A participant planning a meeting with a defined group of persons and possibly a defined topic will inform and invite the wanted participants at a sufficiently early stage. If an undefined group of persons is to be reached, for example, for a cultural event, notice of this meeting can be given in good time, for example, in print media or, also, on the internet.

On the internet, services are offered by means of so-called search engines which permit a search for particular information which is stored, in the form of electronic documents or internet pages or web pages, on a plurality of internet servers. For this purpose, an (internet) user first requests a particular web page from a selected search engine. As a response, the user obtains a so-called form, i.e., a web page with the facility to enter search criteria. The user completes this form accordingly, for example, by entering the search criteria as free text and/or be selecting predefined search criteria, and returns the completed web page to the search engine. The search engine then ascertains a search result, compiles a corresponding results list and sends this results list, as a search response, to the user. This results list contains, for example, a list of addresses of searched web pages, i.e., of web pages which correspond to the search criteria. The said addresses can be presented in the form of IP addresses; instead of this however, readable character strings, so-called uniform resource locators (URL), which uniquely identify these IP addresses, are presented, for example, the character string www.alcatel.com for the company Alcatel. At the present time, however, there is no known search service of this type which provides a searching user with current information on users with the same search inquiries.

Due to increasing mobility, many people frequently have to spend time in unfamiliar locations. Users of a mobile telephony network, however, have the facility of convenient communication with other users at any time. Generally, however, known services of mobile telephony networks, and also of conventional telephone networks, serve to establish communication connections to known users or known services. There is also, however, a demand for the capability to establish spontaneous social contact with like-minded persons, using modern communication means, outside known locations and outside events organized by third parties.

### SUMMARY OF THE INVENTION

The object of the invention is to create a convenient and transparent method, and the means necessary for its execution, for providing a service for organizing meetings.

The fundamental concept of the invention is the mediated provision of meeting proposals, by means of a device of the communication network, to users of this communication network who are searching for meetings. For this purpose, meeting proposals from users proposing or initiating meetings are in each case logged in the service computer with at least one meeting criterion which characterizes a meeting. A searching user transmits a meeting request, with one search criterion or several search criteria, to the service computer. The service computer ascertains meeting proposals the meeting criteria of which correspond to the transmitted search criteria and, if one or more meeting proposals have been ascertained, sends to the searching user at least one of these meeting proposals together with, respectively, current information on participants, in particular, on participants with existing attendance confirmations or on participants who are present, for example, the respective number of these participants. The searching user finally transmits to the service computer an attendance confirmation in respect of a selected meeting proposal, whereupon data of this user, in particular, the address or call number, is stored in the service computer.

### BRIEF DESCRIPTION OF THE DRAWINGS

Further advantageous developments of the invention are disclosed by the dependent claims and the description.

The invention is explained further in the following, with reference to the drawing, wherein:

FIG. 1 shows, in schematic form, a communication network according to the invention for execution of the method according to the invention.

FIG. 1 shows a communication network CN which consists, for example, of a telephone network TN (for mobile communication) and the internet INT. The telephone network TN is provided, by way of example, with a WAP (wireless application protocol) server WP. In addition, the internet INT is provided with a service computer MS and a databank DB. Also represented, by way of example, are a first (service) user SA and a second (service) user SB of the telephone network TN, each of whom are connected to the WAP server WP via a respective radio communication link, not represented here. A third user SC of the internet INT, represented by way of example, is connected to the service computer MS via an internet access network, not represented here. The service computer MS additionally has a connection to the WAP server WP and to the databank DB respectively.

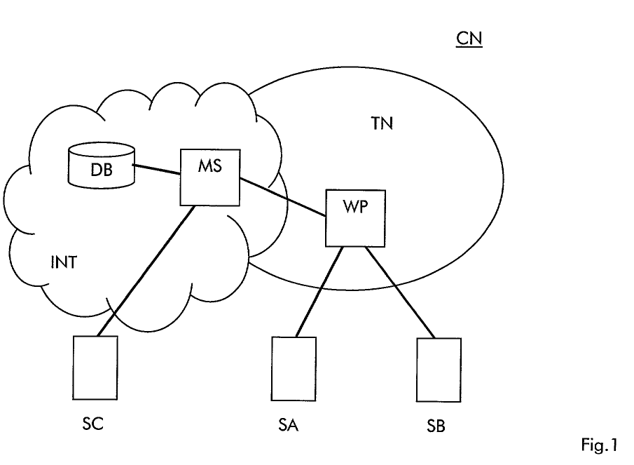

The internet INT comprises all interconnected networks which communicate by means of the internet protocol (IP). According to this definition, separate networks, so-called intranets, are also considered as part of the internet in this case. The so-called world-wide web (WWW) comprises all the devices of the internet which exchange so-called HTML (hypertext markup language) pages, also referred to in short below as web pages, by means of defined application protocols, generally by means of the so-called hypertext transfer protocol (HTTP) as a so-called application layer above the protocol layers of the so-called TCP/IP (transfer control protocol/internet protocol) protocol suite. In the following, all of the above-mentioned protocol layers for the transmission of web pages on the internet are to be termed simply HTTP/TCP/IP protocol suite.

The service computer MS is a so-called internet server or WWW (world-wide web) server which, by means of the hypertext transfer protocol (HTTP), communicates, i.e., exchanges web pages, with other internet terminals connected to the internet, represented in this case, for example, by the third user SC, or with other network servers. For the purpose of communicating with a user SA, SB or SC, the service computer MS generates defined web pages, so-called forms, which contain defined input fields in which the respective user can enter information. The entered information (not the entire web page) is returned to the service computer MS by confirmation, for example, by pressing the “return key” or by selecting or clicking on a screen button provided for this purpose. In addition to the described communication function, the service computer MS also has functions for service control, management and storage of relevant data of the method according to the invention for providing a service for organizing meetings, referred to in short below as a meeting service. The data is preferably stored in the databank DB. The service computer MS can consist of a central computer or multi-computer system or of several decentralized computers communicating with one another. In particular, the various tasks which have been described, for example, the service control, the data management and the web page communication, can also be assigned to physically distinct computers.

The third user SC is realized by, for example, a PC (personal computer) which comprises a so-called WWW browser, i.e., program means for executing the above-mentioned protocols and for displaying and editing web pages on a screen. For the purpose of calling up a web page of the service computer MS, the third user SC sends a unique address, also called a “unified resource locator” (URL), which identifies this web page, or a name which is uniquely associated with it.

The telephone network TN represents a WAP-capable mobile telephony network, for example, a mobile telephone network according to the widespread GSM standard (global system for mobile communication). The above-mentioned wireless application protocol (WAP) describes a protocol suite which serves to communicate so-called WAP pages between a WAP server and a WAP terminal, i.e., a mobile telephony terminal with a so-called WML browser (WML=wireless mark-up language). The wireless application protocol (WAP) or the WAP protocol suite is divided into different protocol layers, in a manner similar to the internet protocols (HTML, HTTP, TCP/IP) described above. The wireless application protocol (WAP) and the corresponding WAP pages are specially adapted for mobile telephony transmission and for display on (small) mobile telephony terminals. For example, WAP pages do not contain any image representations. The users SA and SB represent mobile telephony terminals, each of which has a so-called WAP browser. From the point of view of the user, the communication by means of WAP pages is largely identical to the previously described communication on the internet by means of web pages. It is to be assumed in the following that the service computer MS generates web pages which can also be displayed as WAP pages. The WAP server is then used solely for protocol conversion from the HTML/TCP/IP protocol suite to the WAP protocol suite and vice versa, i.e., as an interface or gateway between the so-called “world-wide web” and the WAP-capable mobile telephony network.

A simple functional communication sequence for setting up a meeting proposal and processing a meeting request within the scope of the method according to the invention is to be described in the following. The sequence can be described in two parts:

1. Logging of a meeting proposal:

the first user SA sends a request to the service computer MS for the setting up of a meeting proposal,

the service computer MS transmits a form for the input of meeting criteria for the meeting proposal to be issued, in which, for example, the meeting location and time (start or duration) must be entered, a category must be selected from a list of several predefined categories and further information can be optionally entered as free text,

the first user completes the said form and sends it to the service computer MS.

the service computer MS checks the received form and, if the result of the check is positive, logs this meeting proposal with the entered information, and informs the first user SA.

2. Logging of a meeting request:

the second user SB sends a request to the service computer MS for the purpose of issuing a meeting request,

the service computer MS transmits a form for the input of search criteria for the meeting request to be issued in which, for example, it is necessary to enter the time or a period and a location, and one or more categories can be selected from a list of several predefined categories,

the second user SB completes the said form and sends it to the service computer MS,

the service computer MS ascertains meeting proposals the meeting criteria of which correspond to the transmitted search criteria, a correspondence consisting, for example, in that all or defined search criteria (for example, location and time criterion) match the corresponding meeting criteria or the search criteria are covered by the meeting criteria,

if one or more matching meeting proposals have been found, these, or one of these meeting proposals, are/is transmitted to the second user with, respectively, the corresponding meeting criteria and current information on participants, for example, the number of participants who have hitherto confirmed attendance and have not subsequently cancelled and/or a list of these participants with their call numbers,

the second user SB selects a meeting proposal and transmits a message, in the form of an attendance confirmation, to the service computer MS, and

the service computer MS stores the message of this user SB.

In the simplest case, the data of the user SB which is to be stored consists solely of the attendance confirmation. In this case, only the current number of participants, i.e., the current number of confirmations is counted and communicated, as participant information, to each of the other searching users. Preferably, however, additional data is stored, for example, the name, call number or (network) address of the user and other information relating to the respective person. This information is communicated, as participant information, in the form of a table. The user interface can be designed so that the searching user only has to press a key in order to initiate the establishment of a connection to the selected other user.

In a further embodiment, in the event of no corresponding meeting proposal being ascertained for the meeting requirement of the second user SB, a meeting proposal is immediately established with this meeting requirement. For this purpose, the service computer MS transmits to the second user, with the search result, an option to this effect (possibly a field to be marked, with the question whether the establishment of a meeting proposal is required) and possibly a prompt to send information which is still missing, for example, the exact location and period of the meeting.

In a further embodiment, a stored meeting proposal is automatically deleted in the service computer MS when a defined time criterion is fulfilled. The start of the day following the meeting can be used as a time criterion. Alternatively, the first user SA can be prompted, upon entry of the meeting criteria, to enter the time of the (anticipated) end of the meeting. This time, or a time separated from it by a certain interval, can then be used as a time criterion.

Users of a cellular mobile telephony network, for example, the GSM network, are continuously located. As soon as a user leaves a so-called geographical area of the network and enters a new geographical area, this user and the new geographical area are entered in a so-called visitors location register, VLR. Moreover, methods are known which permit a substantially more precise location, beyond the location of a geographical area, e.g., by means of field strength measurements of the radio signals received from the mobile terminal. Alternatively, a user can also be precisely located by means of the known so-called global positioning system (GPS). In a further embodiment, user location is used to determine whether a user who has confirmed a meeting is present at the meeting location or has reached a certain locality. It can also be determined by this means when a user, having reached the meeting location, subsequently leaves that location. This information is signalled to the service computer MS. The participant information transmitted to the searching second user SB then additionally includes the number of participants present at the meeting location and, optionally, a list of these participants. Alternatively, the messages relating to presence and absence can also be sent manually to the service computer MS by the second user SB.

In principle, all users SA, SB and SC can contact the service computer at any time in order to obtain information on the status of a meeting (e.g. number and list of participants) through, for example, a new search request. Alternatively, it is possible for the participants of a meeting to be informed, at defined time intervals, on the status of the meeting. A reminder message and information for finding the meeting location can be transmitted to the participants at a defined time prior to a meeting. In the case of a user being located, this user can obtain current navigation information, i.e., a route which is dependent on his current location and on a selected means of transport.

In a further embodiment, users for whom an attendance confirmation for a meeting is stored in the service computer can be subsequently deleted from the list of participants. This deletion can be explicit, as a result of information sent to the service computer by the user concerned. The deletion can also be effected following ascertainment that a participant has left the previously reached meeting location. In this case, the deletion is advantageously effected only after the start of the meeting, in order to prevent deletion of an attendance confirmation in the case of, for example, a prior inspection of the meeting place.

In addition to the above-mentioned content of the participant information, for example, the number of attendance confirmations, the number of participants present and the corresponding participant lists, this participant information can also contain further information, for example, particular interests of the participants. A corresponding free text field can be provided on the input form for the purpose of logging this information from the users who are searching for meetings.

In an alternative embodiment for a communication network CN according to the invention, the functionality of the WAP server WP is extended. The WAP server WP communicates independently with the users SA and SB by means of WAP pages, whereas essentially only payload data, i.e., data relevant to the service, excluding data based on the TCP/IP protocol suite, is exchanged between the WAP server WP and the service computer MS. Information which is only for menu guidance of the users can be generated locally by the WAP server. Furthermore, an additional internet server can be provided which, in a manner analogous to the said WAP server, communicates with the third user SC by means of web pages. This internet server, likewise, essentially exchanges only payload data with the service computer MS. The generation of the web pages with the information obtained by the service computer MS and the extraction of payload information from web pages received by the users is performed by this internet server. The service computer MS is then essentially responsible only for the control of the service, the storage of relevant data and the ascertainment of meeting proposals.

In an alternative embodiment of the method according to the invention, users without WAP access and without internet access are also able to participate in the meeting service. A defined service call number is then assigned to the meeting service. When a call is made using this service call number, for example, initiated by the second user SB, a connection is established between the second user SB and a speech server which logs the search criteria that are transmitted in speech form, converts them into digital information by means of a so-called speech-to-text conversion, and transmits this information to the service computer MS. The meeting proposals ascertained by the service computer MS are transmitted to the speech server, which converts this information into speech by means of a so-called text-to-speech conversion and transmits the corresponding speech information to the second user. The control of this service can be realized by, for example, a so-called service control point (SCP) of the mobile telephony network or of the intelligent network superposed on the conventional telephone network.

1. Method for providing a service for organizing meetings for users of a communication network, comprising the following steps:
a service computer receives and stores one or more meeting proposals of a proposing user or proposing users with, respectively, at least one meeting criterion,
the service computer receives a meeting request, with at least one search criterion, of a searching user,
the service computer ascertains meeting proposals the meeting criteria of which correspond to the transmitted search criteria and, if one or more meeting proposals are ascertained, sends to the searching user at least one of these meeting proposals together with, respectively, current information on participants of this meeting for whom messages are stored,
the service computer receives an attendance confirmation of the searching user in respect of a selected meeting proposal, and
the attendance confirmation of this user is stored as a message in the service computer.

2. Method according to claim 1, wherein additional data of the searching user is stored in the service computer with the attendance confirmation, in particular, his call number or address at which he can be reached via the communication network, and the current information on participants contains the corresponding stored data.

3. Method according to claim 1, wherein, if no corresponding meeting proposal can be ascertained for the meeting request of the searching user, the service computer receives a request from this user to store this meeting request as a meeting proposal.

4. Method according to claim 1, wherein a meeting proposal stored in the service computer is automatically deleted when defined criteria are fulfilled.

5. Method according to claim 1, wherein the service computer receives a message that the searching user is present at the meeting location.

6. Method according to claim 1, wherein the searching user is located for the purpose of ascertaining his presence at the meeting location and the information concerning his presence is signalled to the service computer.

7. Method according to claim 6, wherein the user receives navigation information for reaching the meeting location.

8. Method according to claim 1, wherein the searching user is deleted from a list of participants in the service computer if he cancels a confirmed meeting attendance or the end of his presence at the meeting location is ascertained.

9. Communication network for providing a service for organizing meetings for users, with the following means:
receiving means for receiving meeting proposals with at least one meeting criterion, meeting searches with at least one search criterion, and messages,
memory means for storing meeting proposals and attendance confirmations,
search means for ascertaining appropriate stored meeting proposals for a received meeting search,
compilation means for compiling information on at least one meeting proposal and current information on participants of this meeting, provided that at least one meeting proposal has been ascertained, and
transmitting means for transmitting the said information to the searching user.

10. Service computer for providing a service for organizing meetings for users of a communication network, with the following means:
connection means for establishing a communication connection with users,
receiving means for receiving meeting proposals with at least one meeting criterion, meeting searches with at least one search criterion, and messages,
memory means for storing meeting proposals and messages,
search means for ascertaining appropriate stored meeting proposals for a received meeting search,
compilation means for compiling information on at least one meeting proposal with current information on participants of this meeting for whom messages exist, provided that at least one appropriate meeting proposal has been ascertained, and
transmitting means for transmitting the said information to the searching user.

11. Program module, to be executed in a service computer, for organizing meetings for users of a communication network, for controlling the following steps:
receipt of a meeting request of a searching user,
ascertainment of stored meeting proposals which match this meeting request,
transmission, to the searching user, of information on at least one meeting proposal with current information on participants of this meeting for whom messages exist, and
receipt and storage of messages, particularly attendance confirmations, of the user.
